(19) United States
(12) Patent Application Publication
(10) Pub. No.: US 2024/0205828 A1
(43) Pub. Date: Jun. 20, 2024

(54) APPARATUS, SYSTEM, AND METHOD OF SETTING AN IDLE TIMEOUT PERIOD FOR A WIRELESS COMMUNICATION LINK

(71) Applicant: INTEL CORPORATION, SANTA CLARA, CA (US)

(72) Inventors: Venkateshan Udhayan, Portland, OR (US); Nevo Idan, Zichron Ya'akov (IL); Leor Rom, Haifa (IL)

(73) Assignee: INTEL CORPORATION, SANTA CLARA, CA (US)

(21) Appl. No.: 18/083,535

(22) Filed: Dec. 18, 2022

(51) Int. Cl. H04W 52/02; H04W 76/20

(52) U.S. Cl. CPC H04W 52/0235; H04W 76/20

(57) ABSTRACT

For example, an apparatus may include circuitry and logic configured to cause a wireless communication device to identify an end-to-end network latency of a data stream communicated between the wireless communication device and an endpoint via a wireless communication link between the wireless communication device and an Access Point (AP); and to set an idle timeout period for the wireless communication link based on the end-to-end network latency of the data stream. For example, the idle timeout period includes a time period after which the wireless communication device is to be allowed to switch the wireless communication link from an active mode to a power save mode when the wireless communication link is idle.

### TECHNICAL FIELD

Aspects described herein generally relate to setting an idle timeout period for a wireless communication link.

### BACKGROUND

A wireless communication device may utilize a power save mechanism to reduce power consumption, e.g., to save battery life.

For example, the wireless communication device may switch a wireless communication link between the wireless communication device and an Access Point (AP) from an active mode to a power save mode, for example, when the wireless communication link is idle for an idle timeout period.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of first and second communication schemes of a wireless communication device corresponding to first and second respective idle timeout periods, to demonstrate a technical problem, which may be solved in accordance with some demonstrative aspects.

FIG. 3 is a schematic illustration of a graph depicting response times of a wireless communication device versus a network latency, to demonstrate a technical problem which may be solved in accordance with some demonstrative aspects.

FIG. 4 is a schematic block diagram illustration of an idle timeout control scheme, in accordance with some demonstrative aspects.

FIG. 5 is a schematic flow-chart illustration of a method of setting an idle timeout period for a wireless communication link, in accordance with some demonstrative aspects.

FIG. 6 is a schematic flow-chart illustration of a method of setting an idle timeout period for a wireless communication link, in accordance with some demonstrative aspects.

FIG. 7 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a sensor device, an Internet of Things (IOT) device, a wearable device, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing IEEE 802.11 standards (including IEEE 802.11-2020 (IEEE 802.11-2020, IEEE Standard for Information Technology—Telecommunications and Information Exchange between Systems Local and Metropolitan Area Networks—Specific Requirements Part 11: Wireless LAN Medium Access Control (MAC) and Physical Layer (PHY) Specifications, December 2020)), and/or future versions and/or derivatives thereof, devices and/or networks operating in accordance with existing cellular specifications and/or protocols, and/or future versions and/or derivatives thereof, units and/or devices which are part of the above networks, and the like.

Some aspects may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), Spatial Divisional Multiple Access (SDMA), Time-Division Multiplexing (TDM), Time-Division Multiple Access (TDMA), Multi-User MIMO (MU-MIMO), General Packet Radio Service (GPRS), extended GPRS (EGPRS), Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP. Long Term Evolution (LTE), LTE advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that is integrated with a computer, or a peripheral that is attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated, or group) and/or memory (shared, dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative aspects may be used in conjunction with a WLAN, e.g., a WiFi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a sub 8 GHz frequency band, e.g., a frequency band of 2.4 GHz, 5 GHZ, and/or 6-7 GHz. However, other aspects may be implemented utilizing any other suitable wireless communication frequency bands, for example, an Extremely High Frequency (EHF) band (the millimeter wave (mmWave) frequency band), e.g., a frequency band within the frequency band of between 20 GHz and 300 GHz, a WLAN frequency band, a WPAN frequency band, and the like.

The term “antenna”, as used herein, may include any suitable configuration, structure, and/or arrangement of one or more antenna elements, components, units, assemblies, and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

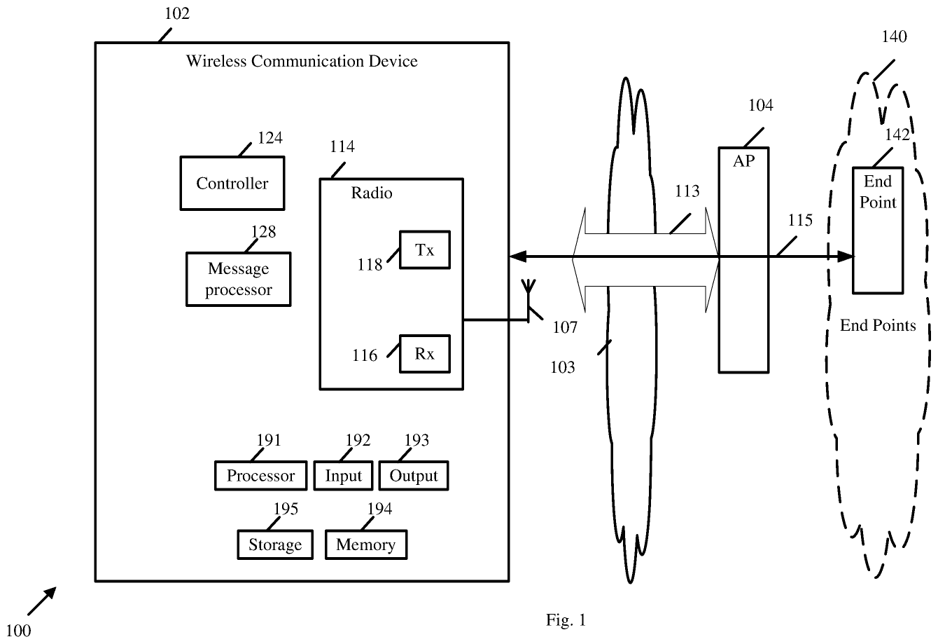

Reference is now made to FIG. 1, which schematically illustrates a block diagram of a system 100, in accordance with some demonstrative aspects.

As shown in FIG. 1, in some demonstrative aspects, system 100 may include a wireless communication network including one or more wireless communication devices, e.g., a wireless communication device 102.

In some demonstrative aspects, wireless communication device 102 may include, for example, a UE, an MD, a STA, an AP, a PC, a desktop computer, a mobile computer, a laptop computer, an Ultrabook™ computer, a notebook computer, a tablet computer, a server computer, a handheld computer, an Internet of Things (IOT) device, a Bluetooth (BT) device, a Bluetooth Low Energy (BLE) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a video source, an audio source, a video sink, an audio sink, a stereo tuner, a broadcast radio receiver, a digital audio player, a speaker, an audio receiver, an audio amplifier, a gaming device, a data source, a data sink, a media player, a Smartphone, a television, a music player, or the like.

In some demonstrative aspects, device 102 may include, operate as, and/or perform the functionality of one or more STAs. For example, device 102 may include at least one STA.

In some demonstrative aspects, device 102 may include, operate as, and/or perform the functionality of one or more WLAN STAs.

In some demonstrative aspects, device 102 may include, operate as, and/or perform the functionality of one or more Wi-Fi STAs.

In one example, a station (STA) may include a logical entity that is a singly addressable instance of a medium access control (MAC) and physical layer (PHY) interface to the wireless medium (WM). The STA may perform any other additional or alternative functionality.

In some demonstrative aspects, device 102 may include a non-AP STA.

In one example, an AP may include an entity that contains a station (STA), e.g., one STA, and provides access to distribution services, via the wireless medium (WM) for associated STAs. The AP may perform any other additional or alternative functionality.

In one example, a non-AP STA may include a STA that is not contained within an AP. The non-AP STA may perform any other additional or alternative functionality.

In some demonstrative aspects, device 102 may include, operate as, and/or perform the functionality of a BT device.

In some demonstrative aspects, device 102 may include, operate as, and/or perform the functionality of a cellular communication device.

In some demonstrative aspects, device 102 may include, operate as, and/or perform the functionality of, any other devices and/or STA.

In some demonstrative aspects, device 102 may include, for example, one or more of a processor 191, an input unit 192, an output unit 193, a memory unit 194, and/or a storage unit 195. Device 102 may optionally include other suitable hardware components and/or software components. In some demonstrative aspects, some or all of the components of device 102 may be enclosed in a common housing or packaging, and may be interconnected or operably associated using one or more wired or wireless links. In other aspects, components of device 102 may be distributed among multiple or separate devices.

In some demonstrative aspects, processor 191 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 executes instructions, for example, of an Operating System (OS) of device 102 and/or of one or more suitable applications.

In some demonstrative aspects, input unit 192 may include, for example, a keyboard, a keypad, a mouse, a touch-screen, a touch-pad, a track-ball, a stylus, a microphone, or other suitable pointing device or input device. Output unit 193 includes, for example, a monitor, a screen, a touch-screen, a flat panel display, a Light Emitting Diode (LED) display unit, an Organic LED (OLED) display unit, a Liquid Crystal Display (LCD) display unit, a plasma display unit, one or more audio speakers or earphones, or other suitable output devices.

In some demonstrative aspects, memory unit 194 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 includes, for example, a hard disk drive, a Solid State Drive (SSD), or other suitable removable or non-removable storage units. Memory unit 194 and/or storage unit 195, for example, may store data processed by device 102.

In some demonstrative aspects, wireless communication device 102 may be capable of communicating content, data, information, and/or signals via a wireless medium (WM) 103.

In some demonstrative aspects, wireless medium 103 may include, for example, a radio channel, a wireless communication channel, a BT channel, a BLE channel, a cellular channel, a Global Navigation Satellite System (GNSS) Channel, an RF channel, a WiFi channel, an IR channel, and the like.

In some demonstrative aspects, wireless communication medium 103 may include a sub-8 Ghz frequency band, for example, a 2.4 GHz frequency band, a 5 GHz frequency band, and/or a 6-7 GHz frequency band, and/or one or more other wireless communication frequency bands, for example, a millimeterWave (mmWave) frequency band, e.g., a 60 GHz frequency band, a Sub-1 GHz (S1G) band, and/or any other frequency band.

In some demonstrative aspects, device 102 may include one or more radios including circuitry and/or logic to perform wireless communication between device 102, and one or more other devices. For example, device 102 may include at least one radio 114.

In some demonstrative aspects, radio 114 may include one or more wireless receivers (Rx) including circuitry and/or logic to receive wireless communication signals, RF signals, frames, blocks, transmission streams, packets, messages, data items, and/or data. For example, radio 114 may include at least one receiver 116.

In some demonstrative aspects, radio 114 may include one or more wireless transmitters (Tx) including circuitry and/or logic to transmit wireless communication signals, RF signals, frames, blocks, transmission streams, packets, messages, data items, and/or data. For example, radio 114 may include at least one transmitter 118.

In some demonstrative aspects, radio 114, transmitter 118, and/or receiver 116 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like.

In some demonstrative aspects, radio 114 may be configured to communicate over a sub 8 GHz band, e.g., a 2.4 GHz band, a 5 GHz band, and/or a 6-7 GHz band, and/or any other frequency band, e.g., a 60 GHz band, an S1G band, and/or any other band.

In some demonstrative aspects, radio 114 may include, or may be associated with one or more antennas 107.

Antennas 107 may include any type of antennas suitable for transmitting and/or receiving wireless communication signals, blocks, frames, transmission streams, packets, messages and/or data. For example, antennas 107 may include any suitable configuration, structure, and/or arrangement of one or more antenna elements, components, units, assemblies, and/or arrays. In some aspects, antennas 107 may implement transmit and receive functionalities using separate transmit and receive antenna elements. In some aspects, antennas 107 may implement transmit and receive functionalities using common and/or integrated transmit/receive elements.

In some demonstrative aspects, device 102 may include a controller 124 configured to perform and/or to trigger, cause, instruct and/or control device 102 to perform, one or more communications, to generate and/or communicate one or more messages and/or transmissions, and/or to perform one or more functionalities, operations and/or procedures between device 102 and one or more other devices, e.g., as described below.

In some demonstrative aspects, controller 124 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controller 124. Additionally or alternatively, one or more functionalities of controller 124 may be implemented by logic, which may be executed by a machine and/or one or more processors, e.g., as described below.

In some demonstrative aspects, one or more functionalities and/or operations of controller 124 may be implemented as part of a host processor of device 102.

In some demonstrative aspects, one or more functionalities and/or operations of controller 124 may be implemented as part of a Software (SW) component and/or application to be executed by the host processor of the device 102.

In some demonstrative aspects, one or more functionalities and/or operations of controller 124 may be implemented as part of a driver of the host processor of the device 102.

In some demonstrative aspects, at least part of the functionality of controller 124 may be implemented as part of one or more elements of radio 114.

In some demonstrative aspects, one or more functionalities and/or operations of controller 124 may be implemented as part of a Firmware (FW) component of a radio chip implementing radio 114.

In other aspects, the functionality of controller 124 may be implemented as part of any other element of device 102.

In some demonstrative aspects, device 102 may include a message processor 128 configured to generate, process and/or access one or more messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), e.g., a PHY Layer Convergence Procedure (PLCP) PDU, for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, message processor 128 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, BB circuitry and/or logic, a BB processor, a BB memory, AP circuitry and/or logic, an AP processor, an AP memory, and/or any other circuitry and/or logic, configured to perform the functionality of message processor 128, respectively. Additionally or alternatively, one or more functionalities of message processor 128 may be implemented by logic, which may be executed by a machine and/or one or more processors, e.g., as described below.

In some demonstrative aspects, at least part of the functionality of message processor 128 may be implemented as part of radio 114.

In some demonstrative aspects, at least part of the functionality of message processor 128 may be implemented as part of controller 124.

In other aspects, the functionality of message processor 128 may be implemented as part of any other element of device 102.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of radio 114. For example, the chip or SoC may include one or more elements of controller 124, one or more elements of message processor 128, and/or one or more elements of radio 114. In one example, controller 124, message processor 128, and radio 114 may be implemented as part of the chip or SoC.

In other aspects, controller 124, message processor 128 and/or radio 114 may be implemented by one or more additional or alternative elements of device 102.

In some demonstrative aspects, device 102 may include, operate as, perform the role of, and/or perform one or more functionalities of, one or more STAs.

In some demonstrative aspects, device 102 may form, or may communicate as part of, a wireless local area network (WLAN).

In some demonstrative aspects, device 102 may form, or may communicate as part of, a WiFi network.

In other aspects, device 102 may form, and/or communicate as part of, any other additional or alternative network.

In some demonstrative aspects, device 102 may communicate one or more data streams with one or more endpoints 140, e.g., as described below.

In some demonstrative aspects, device 102 may communicate a plurality of data streams with a plurality of endpoints 140, e.g., as described below.

In some demonstrative aspects, device 102 may communicate the plurality of data streams with the plurality of endpoints 140, for example, via at least one wireless communication link 113 between the wireless communication device 102 and at least one AP 104, e.g., as described below.

In some demonstrative aspects, device 102 may communicate, for example, a data stream 115 with an endpoint 142, for example, via the wireless communication link 113 between the wireless communication device 102 and the AP 104, e.g., as described below.

In some demonstrative aspects, radio 114 may be configured to communicate the data stream 115 with AP 104, for example, via the wireless communication link 113.

In some demonstrative aspects, endpoint 142 may include a server, a cloud server, a host server, a network server, a cloud DB, and/or any other endpoint.

In some demonstrative aspects, wireless communication device 102 may be configured to utilize a power management mechanism, for example, to manage a power consumption of wireless communication device 102, for example, with respect to wireless communications performed by wireless communication device 102, e.g., as described below.

In some demonstrative aspects, for example, controller 124 may be configured to implement one or more functionalities and/or operations of the power management mechanism, e.g., as described below.

In some demonstrative aspects, the power management mechanism may be configured to provide a technical solution to reduce power consumption, e.g., to save battery life, of the wireless communication device 102 for example, with respect to wireless communications performed by wireless communication device 102, e.g., as described below.

For example, in some use cases, scenarios, and/or deployments, wireless communication networks, e.g., Wi-Fi networks, may be heavy utilized, for example, in case most of the wireless devices in the wireless communication network are maintained connected to the Internet most of the time, or even all of the time. Accordingly, keeping a wireless communication device always active may be highly inefficient, e.g., in terms of battery life, and/or system thermals.

For example, the power management mechanism may be implemented for one or more, e.g., some or even all, types of a data traffic pattern, which may have both active periods and idle periods.

In some demonstrative aspects, the power management mechanism may be configured to implement a power save mode (PSM), for example, to provide a technical solution to support improved battery life at the wireless communication device, e.g., as described below.

In some demonstrative aspects, the power save mode may be configured to utilize an idle timeout period, for example, to allow the wireless communication device to move into the power save mode, for example, when the wireless communication device detects idleness of the wireless communication link.

For example, the idle timeout period may be implemented to provide a technical solution to support improved power consumption. In one example, the idle timeout period may be utilized by wireless communication device 102 to schedule transmissions with AP 104, for example, in a power-efficient manner.

In some demonstrative aspects, for example, in some use cases, scenarios, and/or implementations, there may be one or more disadvantages, inefficiencies, and/or technical issues in implementing a power management mechanism utilizing a static, e.g., a default, idle timeout period, e.g., as described below.

For example, using a static idle timeout period may impact responsiveness of a wireless communication device. For example, the static idle timeout period may not be efficient, for example, to react to changing network and/or platform context, e.g., as described below.

For example, network latency may impact responsiveness of the wireless communication device, for example, in case a static idle timeout period is used, e.g., as described below.

In one example, setting a static idle timeout period to a constant value of 100 milliseconds (ms) may support device power saving. However, this constant idle timeout value may not be suitable, for example, in terms of performance, e.g., as described below.

For example, a wireless communication device utilizing a static idle timeout value, e.g., 100 ms, may move into the power save mode, for example, based on detection of an idle communication link for the static idle timeout value. In some use cases and/or scenarios, this situation may result in degraded responsiveness and/or latency of the wireless communication device.

For example, implementation of the static idle timeout value, e.g., 100 ms, may result in increased latency in a response of the wireless communication device, for example, in case of a network latency, which is longer than the static idle timeout, e.g., as described below.

For example, in some cases and/or scenarios, for example, in case of relatively high network latency, implementation of the static idle timeout value, e.g., 100 ms, may result in the wireless communication device moving into the power save mode, for example, a few times, for example, while there may still be traffic expected to be delivered to the wireless communication device.

In one example, the wireless communication device may receive from a network endpoint traffic to be rendered, for example, on a display. For example, in case of relatively high network latency, implementation of the static idle timeout value may result in the wireless communication device moving into the power save mode a few times, for example, while there may still be traffic expected to be delivered to a CPU/GPU of the wireless communication device, for example, for rendering into display.

For example, in many use cases, implementations and/or scenarios, application response time may be dependent on multiple network transactions. Accordingly, a total duration of the transactions may be in direct correlation with a network latency and/or a rendering latency. According to this example, it may be derived that network performance may be exchanged with CPU performance.

In some demonstrative aspects, for example, in some use cases, scenarios, and/or implementations, there may be one or more disadvantages, inefficiencies, and/or technical problems, for example, to configure a power management mechanism utilizing a static idle timeout period, for example, which does not take into consideration a network latency, e.g., as described below.

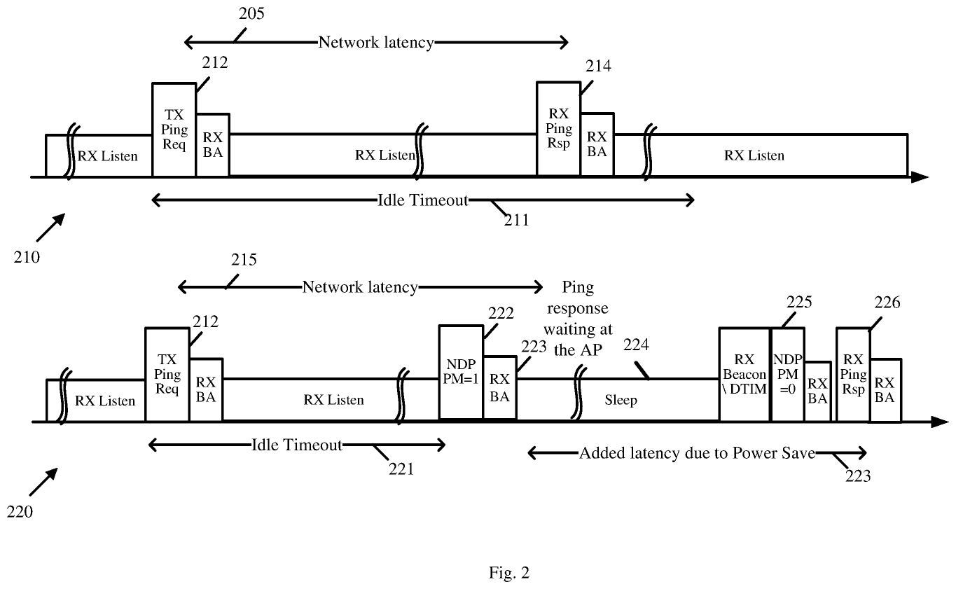

Reference is made to FIG. 2, which schematically illustrates a first communication scheme 210 of a wireless communication device, and a second communication scheme 220 of the wireless communication device, to demonstrate a technical problem, which may be solved in accordance with some demonstrative aspects.

For example, as shown in FIG. 2, the wireless communication device may transmit a ping request 212 to an endpoint over a network connection, for example, via a wireless communication link between the wireless communication device and an AP.

For example, as shown in FIG. 2, the first communication scheme 210 may correspond to a situation where a network latency 205 of the network connection may be shorter than an idle timeout period implemented 211 by the wireless communication device with respect to the wireless communication link between the wireless communication device and an AP.

For example, as shown in FIG. 2, the second communication scheme 220 may correspond to a situation where a network latency 215 of the network connection may be longer than an idle timeout period 221 implemented by the wireless communication device with respect to the wireless communication link between the wireless communication device and an AP.

For example, as shown in FIG. 2, according to the first communication scheme 210, the wireless communication device may be required to remain at an active state for at least a duration of the idle timeout period 211. Accordingly, the wireless communication device may be able to receive a ping response message 214 from the endpoint in response to the ping request message 212, e.g., according to the network latency period 205.

For example, as shown in FIG. 2, according to the second communication scheme 220, the wireless communication device may be allowed to switch from the active state to a power save state, for example, based on expiration of the idle timeout period 221, which may be shorter than the network latency period 215. For example, as shown in FIG. 2, the wireless communication device may transmit to the AP a message 222 including an indication of a power save mode, e.g., a Power Mode (PM) bit set to 1. For example, as shown in FIG. 2, the wireless communication device may switch to the power save mode (“sleep”) 224 based on a response message 223 from the AP.

For example, as shown in FIG. 2, according to the second communication scheme 220, the AP may receive a ping response from the endpoint at a later time, e.g., according to the network latency period 215, for example, after the wireless communication device has entered the power save mode. Accordingly, the AP may maintain the ping response, for example, until the wireless communication device switches back from the sleep state to the active state.

For example, as shown in FIG. 2, according to the second communication scheme 220, the wireless communication device may transmit to the AP a message 225 including an indication of an active mode, e.g., a PM bit set to 0.

For example, as shown in FIG. 2, according to the second communication scheme 220, the AP may transmit the ping response message 226 to the wireless communication device, for example, after receipt of the message 225.

For example, as shown in FIG. 2, according to the second communication scheme 220, the idle timeout period 221, which may be shorter than the network latency 215 may result in an additional latency 223 for communication with the endpoint, e.g., dur to the wireless communication device entering the power save mode prematurely.

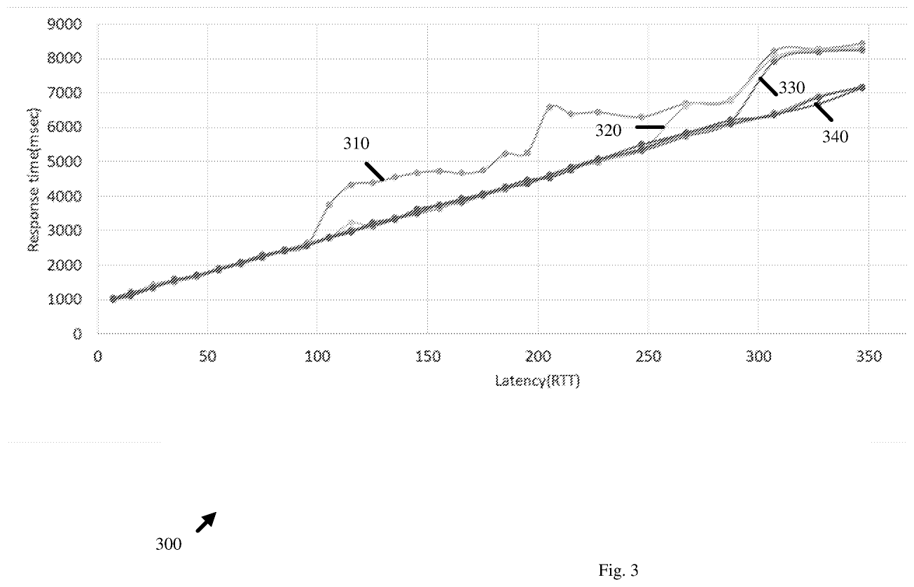

Reference is made to FIG. 3, which schematically illustrates a graph 300 depicting response times of a wireless communication device versus a network latency, to demonstrate a technical problem which may be solved in accordance with some demonstrative aspects.

For example, the graph 300 may represent lab measurements of response times of a wireless communication device with respect to different idle timeout period values. In one example, a response time may represent a web page load time.

As shown in FIG. 3, a first curve 310 depicts response times of the wireless communication device when implementing a static idle timeout period of 100 ms.

As shown in FIG. 3, a second curve 320 depicts response times of the wireless communication device when implementing a static idle timeout period of 250 ms.

As shown in FIG. 3, a third curve 330 depicts response times of the wireless communication device when implementing a static idle timeout period of 300 ms.

As shown in FIG. 3, a fourth curve 340 depicts response times of the wireless communication device when implementing a static idle timeout period of 1000 ms.

As shown in FIG. 3, there may be a direct relationship between the response time and the idle timeout period. For example, as shown in FIG. 3, the longer the idle timeout period, the better the response time.

For example, as shown in FIG. 3, a relatively long idle timeout period, e.g., the idle timeout period of 1000 ms depicted by curve 340, may be optimal in terms of responsiveness, e.g., may support a response without substantially any added delay dur to the power save mode.

As shown in FIG. 3, in cases where the network latency is greater than the idle timeout period, the response time of the wireless communication device may be degraded.

For example, as shown in FIG. 3, a relatively short idle timeout period, e.g., the idle timeout period of 100 ms depicted by curve 310, may result in an increase of more than 1000 ms in the response time, for example, when the network latency is greater than 100 ms.

For example, as shown in FIG. 3, a medium idle timeout period, e.g., the idle timeout period of 250 ms depicted by curve 320, may result in an increase of more 500 ms in the response time, for example, when the network latency is greater than 250 ms; and may result in an increase of more 1000 ms in the response time, for example, when the network latency is greater than 300 ms.

For example, as shown in FIG. 3, a higher idle timeout period, e.g., the idle timeout period of 300 ms depicted by curve 330, may result in an increase of more 1000 ms in the response time, for example, when the network latency is greater than 300 ms.

As shown in FIG. 3, the idle timeout period may have an impact on the response time, which may result in an impact on the web page load time. For example, the relatively short idle timeout period, e.g., the idle timeout period of 100 ms depicted by curve 310, may result in significant degradation of the web page load time, e.g., a load time longer by more than 33%, for example, compared to the medium and long idle time-out periods.

Referring back to FIG. 1, in some demonstrative aspects, controller 124 may be configured to set an idle timeout period of the wireless communication link 113, for example, based on an end-to-end network latency of the data stream 115, e.g., as described below.

In some demonstrative aspects, controller 124 may be configured to track network latency, e.g., the end-to-end network latency, for a data stream e.g., for each data stream, for example, by measuring a Round Trip Time (RTT), and/or any other additional or alternative parameter relating to, representative of, and/or based on, the end-to-end network latency.

In some demonstrative aspects, the RTT may be measured, for example, utilizing a Transmission Control Protocol (TCP) stream establishment protocol. For example, controller 124 may determine the RTT between device 102 and the endpoint 142, for example, based on a Time of Departure (ToD) of a synchronize (SYN) packet from device 102 to the endpoint 142, e.g., via the wireless communication link 113, and based on a Time of Arrival (ToA) of a SYN acknowledgement (SYN-ACK) packet received from endpoint 142, e.g., via the wireless communication link 113, for example, in response to the SYN packet.

In other aspects, the RTT may be measured based on any other additional or alternative mechanism.

In some demonstrative aspects, controller 124 may be configured to track a priority, for a data stream e.g., for each data stream, e.g., as described below.

In some demonstrative aspects, controller 124 may be configured to identify a nature of a server, and/or a system latency of a particular stream, e.g., as described below.

In some demonstrative aspects, controller 124 may be configured to adjust, e.g., to dynamically adjust, an idle timeout period based, for example, on an identified change in the system latency of one or more streams, e.g., as described below.

In some demonstrative aspects, controller 124 may be configured to set, configure, update and/or adjust the idle timeout period, for example, by adjusting one or more Wi-Fi device power management idle timeout values, e.g., as described below.

In some demonstrative aspects, controller 124 may be configured to adjust the idle timeout period, for example, based on one or more streams (“high priority streams”) having a high priority, and a relatively high network latency, e.g., as described below.

In some demonstrative aspects, controller 124 may be configured to set the idle timeout period, for example, to align a power save mode, for example, with the network latency of the high priority streams with the relatively high network latency.

In some demonstrative aspects, controller 124 may be configured to set the idle timeout period based on the network latency of the high priority streams, for example, to provide a technical solution to improve responsiveness and/or a user experience, e.g., as described below.

In some demonstrative aspects, controller 124 may be configured to set the idle timeout period, for example, based on one or more streams (“low priority streams”) having a relatively low priority, and a relatively low network latency, e.g., as described below.

In some demonstrative aspects, controller 124 may be configured to set the idle timeout period, for example, to align the power save mode, for example, with the network latency of the low priority streams with the relatively low network latency.

In some demonstrative aspects, controller 124 may be configured to set the idle timeout period based on the network latency of the low priority streams, for example, to provide a technical solution to improve power consumption, e.g., as described below.

In some demonstrative aspects, controller 124 may be configured to set the idle timeout value, for example, based on identifying, e.g., at a given time, the nature of the data stream 115, for example, in terms of priority, RTT, network latency, inter-arrival time, and/or any other suitable parameter, e.g., as described below.

In some demonstrative aspects, controller 124 may be configured to set an optimal idle timeout value, for example, in terms of responsive time versus device power saving, e.g., as described below.

In some demonstrative aspects, controller 124 may be configured to set the idle timeout period to a value, which may improve platform thermals, for example, by supporting aggressive device power management decisions, e.g., as described below.

In some demonstrative aspects, controller 124 may be configured to set the idle timeout period to a value, which may be configured to improve power consumption for low latency use cases, e.g., as described below.

In one example, setting a long idle timeout period may result in a responsiveness gain, for example, as may be shown by live simulations with different idle timeout values and variable network latency. However, the long idle timeout period may result in an increased power consumption.

In some demonstrative aspects, controller 124 may be configured to set the idle timeout period to support dynamic network power management, for example, by dynamically setting the idle timeout period, e.g., as described below.

In some demonstrative aspects, controller 124 may be configured to set the idle timeout period according to a dynamic network power management scheme, which may be configured to provide a technical solution to support improved user experience, e.g., as described below.

In some demonstrative aspects, controller 124 may be configured to set the idle timeout period according to a dynamic network power management scheme, which may be configured, for example, to reduce end to end latency and/or responsiveness, for example, for high priority and high latency use cases, e.g., as described below.

In some demonstrative aspects, controller 124 may be configured to set the idle timeout period according to a dynamic network power management scheme, which may be configured, for example, to improve power consumption, for example, for low priority and low latency use cases, e.g., as described below.

In some demonstrative aspects, controller 124 may be configured to set the idle timeout period, for example, based on an end-to-end latency, for example, to provide a technical solution to improve user experience, for example, by improving responsiveness of high priority and high latency streams, e.g., as described below.

In some demonstrative aspects, controller 124 may be configured to set the idle timeout period, for example, based on an end-to-end latency, for example, to provide a technical solution to support a significant power saving, for example, for various applications. For example, the dynamic nature of changing the idle timeout values may result in significant power saving, e.g., power saving of about 50%, for example, for voice call applications.

In some demonstrative aspects, controller 124 may be configured to cause, trigger, instruct and/or control wireless communication device 102 to identify an end-to-end network latency of the data stream 115 communicated between the wireless communication device 102 and the endpoint 142 via the wireless communication link 113 between the wireless communication device 102 and the AP 104, e.g., as described below.

In some demonstrative aspects, radio 114 may be configured to communicate the data stream 115 via the wireless communication link 113 between the wireless communication device 102 and the AP 104, e.g., as described below.

In some demonstrative aspects, controller 124 may be configured to cause, trigger, instruct, and/or control the wireless communication device 102 to identify the end-to-end network latency of the data stream 115 based on a Round Trip Time (RTT) between the wireless communication device 102 and the endpoint 142, e.g., as described below.

In other aspects, controller 124 may be configured to cause, trigger, instruct, and/or control the wireless communication device 102 to identify the end-to-end network latency of the data stream 115, for example, based on any other additional or alternative suitable parameter and/or mechanism corresponding to, and/or representing, the end-to-end network latency.

In some demonstrative aspects, controller 124 may be configured to cause, trigger, instruct and/or control the wireless communication device 102 to set an idle timeout period for the wireless communication link 113, for example, based on the end-to-end network latency of the data stream 115, e.g., as described below.

In some demonstrative aspects, the idle timeout period may include a time period after which the wireless communication device 102 may be allowed to switch the wireless communication link 113 from an active mode to a power save mode, for example, when the wireless communication link 113 is idle, e.g., as described below.

In some demonstrative aspects, controller 124 may be configured to prohibit the wireless communication device 102 from switching the wireless communication link 113 to the power save mode, for example, when the wireless communication link 113 is idle for a time period shorter than the idle timeout period.

In some demonstrative aspects, controller 124 may be configured to cause, trigger, instruct, and/or control the wireless communication device 102 to set the idle timeout period to be equal to or greater than the end-to-end network latency of the data stream 115, e.g., as described below.

In some demonstrative aspects, controller 124 may be configured to cause, trigger, instruct and/or control the wireless communication device 102 to set a first idle timeout period for the wireless communication link 113, for example, based on a determination that the end-to-end network latency of the data stream is be a first end-to-end network latency, e.g., as described below.

In some demonstrative aspects, controller 124 may be configured to cause, trigger, instruct and/or control the wireless communication device 102 to set a second idle timeout period for the wireless communication link, for example, based on a determination that the end-to-end network latency of the data stream is a second end-to-end network latency, e.g., as described below.

In some demonstrative aspects, the second idle timeout period may be different from the first idle timeout period, and/or the second end-to-end network latency may be different from the first end-to-end network latency, e.g., as described below.

In some demonstrative aspects, the second idle timeout period may be longer than the first idle timeout period, and the second end-to-end network latency may be greater than the first end-to-end network latency, e.g., as described below.

In some demonstrative aspects, controller 124 may be configured to cause, trigger, instruct, and/or control the wireless communication device 102 to adjust the idle timeout period for the wireless communication link 113, for example, based on a change in the end-to-end network latency, e.g., as described below.

In some demonstrative aspects, controller 124 may be configured to cause, trigger, instruct, and/or control the wireless communication device 102 to increase the idle timeout period for the wireless communication link 113, for example, based on an increase in the end-to-end network latency, e.g., as described below.

In some demonstrative aspects, controller 124 may be configured to cause, trigger, instruct, and/or control the wireless communication device 102 to decrease the idle timeout period for the wireless communication link 113, for example, based on a decrease in the end-to-end network latency, e.g., as described below.

In some demonstrative aspects, controller 124 may be configured to cause, trigger, instruct, and/or control the wireless communication device 102 to selectively set the idle timeout period based on the end-to-end network latency of the data stream 115, for example, based on one or more criteria, e.g., as described below.

In some demonstrative aspects, controller 124 may be configured to cause, trigger, instruct, and/or control the wireless communication device 102 to determine, for example, based on a priority of the data stream 115, whether the idle timeout period is to be set based on the end-to-end network latency of the data stream 115, e.g., as described below.

In some demonstrative aspects, controller 124 may be configured to cause, trigger, instruct, and/or control the wireless communication device 102 to select to set the idle timeout period is to be set based on the end-to-end network latency of the data stream 115, for example, based on a determination that the data stream 115 has a first priority, e.g., as described below.

In some demonstrative aspects, controller 124 may be configured to cause, trigger, instruct, and/or control the wireless communication device 102 to select not to set the idle timeout period is to be set based on the end-to-end network latency of the data stream 115, for example, based on a determination that the data stream 115 has a second priority, e.g., as described below.

In some demonstrative aspects, controller 124 may be configured to cause, trigger, instruct, and/or control the wireless communication device 102 to determine, for example, based on a comparison between a priority of the data stream 115 and a priority threshold, whether the idle timeout period is to be set, for example, based on the end-to-end network latency of the data stream 115, e.g., as described below.

In some demonstrative aspects, controller 124 may be configured to cause, trigger, instruct and/or control the wireless communication device 102 to set a first idle timeout period based on the end-to-end network latency of the data stream 115, for example, based on a determination that the priority of the data stream 115 is above the priority threshold, e.g., as described below.

In some demonstrative aspects, controller 124 may be configured to cause, trigger, instruct, and/or control the wireless communication device 102 to set a second idle timeout period, for example, based on a determination that the priority of the data stream 115 is not above the priority threshold, e.g., as described below.

In some demonstrative aspects, the first idle timeout period may be longer than the second idle timeout period, e.g., as described below.

In some demonstrative aspects, the second idle timeout period may include a default timeout period, e.g., as described below.

In other aspects, the idle timeout period may be set based on any other additional or alternative criteria.

In some demonstrative aspects, controller 124 may be configured to cause, trigger, instruct, and/or control the wireless communication device 102 to set the idle timeout period for the wireless communication link 113, for example, based on an other end-to-end network latency of an other data stream communicated between the wireless communication device 102 and an other endpoint, e.g., of endpoints 140, for example, via the wireless communication link 113, e.g., as described below.

In some demonstrative aspects, controller 124 may be configured to cause, trigger, instruct, and/or control the wireless communication device 102 to increase the idle timeout period for the wireless communication link 113, for example, based on a determination that the other end-to-end network latency of the other data stream is longer than the end-to-end network latency of the data stream 115, e.g., as described below.

In some demonstrative aspects, controller 124 may be configured to cause, trigger, instruct, and/or control the wireless communication device 102 to set the idle timeout period for the wireless communication link 113, for example, based on a criterion corresponding to a plurality of end-to-end latencies corresponding to a plurality of data streams communicated via the wireless communication link 113, e.g., as described below.

In some demonstrative aspects, controller 124 may be configured to cause, trigger, instruct, and/or control the wireless communication device 102 to set the idle timeout period for the wireless communication link 113, for example, based on a maximal end-to-end network latency of the plurality of end-to-end network latencies corresponding to a plurality of data streams communicated via the wireless communication link 113, e.g., as described below.

In some demonstrative aspects, controller 124 may be configured to cause, trigger, instruct, and/or control the wireless communication device 102 to determine whether to include a particular data stream in the plurality of data streams for setting the idle timeout period for the wireless communication link 113, for example, based on a priority of the particular data stream, e.g., as described below.

In some demonstrative aspects, controller 124 may be configured to cause, trigger, instruct, and/or control the wireless communication device 102 to determine whether to include the particular data stream in the plurality of data streams for setting the idle timeout period for the wireless communication link 113, for example, based on a comparison between the priority of the particular data stream and a priority threshold, e.g., as described below.

In some demonstrative aspects, controller 124 may be configured to cause, trigger, instruct, and/or control the wireless communication device 102 to include the particular data stream in the plurality of data streams for setting the idle timeout period for the wireless communication link 113, for example, when the priority of the particular data stream is above or equal to the priority threshold, e.g., as described below.

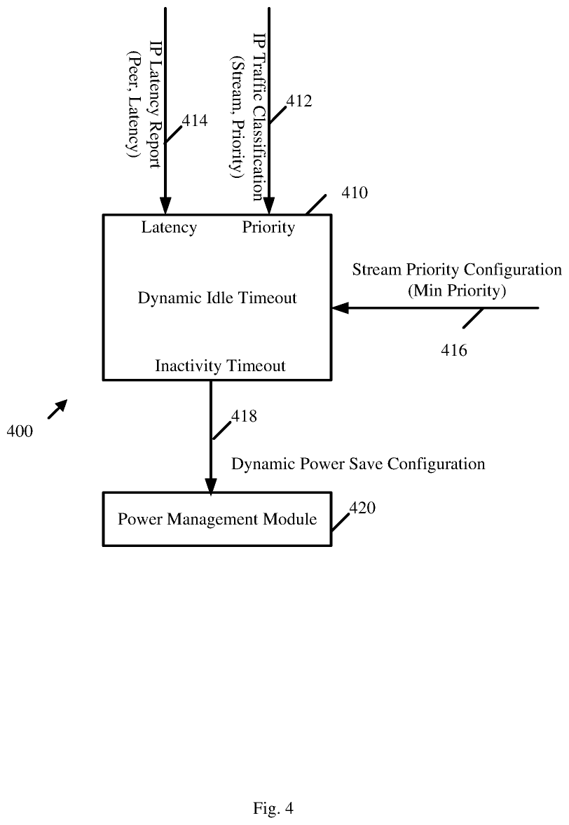

Reference is made to FIG. 4, which schematically illustrates a block diagram of an idle timeout control scheme 400, in accordance with some demonstrative aspects.

In some demonstrative aspects, as shown in FIG. 4, idle timeout control scheme 400 may include a controller 410, for example, a dynamic idle timeout controller, e.g., as described below.

In some demonstrative aspects, controller 410 may be implemented and/or included as part of controller 124 (FIG. 1). For example, controller 124 (FIG. 1) may implement one or more elements of controller 410, and/or may perform one or more operations and/or functionalities of controller 410.

In some demonstrative aspects, one or more functionalities and/or operations of controller 410 may be implemented as part of a host processor of device 102 (FIG. 1).

In some demonstrative aspects, one or more functionalities and/or operations of controller 410 may be implemented as part of a SW component and/or application to be executed by the host processor of device 102 (FIG. 1).

In some demonstrative aspects, one or more functionalities and/or operations of controller 410 may be implemented as part of a driver of the host processor of device 102 (FIG. 1).

In some demonstrative aspects, at least part of the functionality of controller 410 may be implemented as part of one or more elements of radio 114 (FIG. 1).

In some demonstrative aspects, one or more functionalities and/or operations of controller 410 may be implemented as part of a FW component of a radio chip implementing radio 114 (FIG. 1).

In other aspects, one or more functionalities of controller 410 may be implemented as part of any other element of device 102 (FIG. 1).

In some demonstrative aspects, controller 410 may be implemented as a host SW service, which may be configured to track a stream priority of a stream, e.g., data stream 115 (FIG. 1), and a network latency of the stream, e.g., as described below.

In other aspects, controller 410 may be implemented as any other service.

In some demonstrative aspects, controller 410 may be configured to identify and/or to track end-to-end network latencies of one or more data streams, e.g., data stream 115 (FIG. 1).

In some demonstrative aspects, controller 410 may be configured to identify and/or to track the end-to-end network latencies of one or more data streams, for example, based on a latency input 412. For example, the latency input 412 may include an IP latency report, which may include, for example, a peer identifier of a peer, e.g., an endpoint identifier of endpoint 142 (FIG. 1), and network latency information representing a network latency of the peer. In other aspects, the latency input 412 may include any other additional or alternative report and/or information.

In some demonstrative aspects, as shown in FIG. 4, controller 410 may be configured to identify and/or track one or more priorities of one or more data streams, e.g., data stream 115 (FIG. 1), for example, based on a priority input 414. For example, priority input 412 may include an IP traffic classification report, which may include, for example, a stream identifier of a data stream, and priority information indicating a priority of the data stream. In other aspects, the priority input 414 may include any other additional or alternative, or any other report and/or information.

In some demonstrative aspects, as shown in FIG. 4, controller 410 may be configured to receive priority threshold information 416, which may be configured, for example, to indicate a priority threshold, e.g., a minimal priority of a data stream to be considered, for example, for setting an idle timeout period.

In some demonstrative aspects, as shown in FIG. 4, controller 410 may be configured to set an idle timeout period value 418, for example, based on the priority input 414, the latency input 412, and/or the priority threshold information 416, e.g., as described below.

In some demonstrative aspects, controller 410 may be configured to set and/or adjust the idle timeout period value 418, e.g., to control device power-save-modes(active/sleep), for example, according to a common denominator of network latencies of high priority streams, e.g., as described below.

In some demonstrative aspects, controller 410 may be configured to identify one or more identified data streams to be considered for setting the idle timeout period value 418, e.g., as described below.

In some demonstrative aspects, controller 410 may be configured to determine whether to include a particular data stream in the identified data streams to be considered for setting the idle timeout period value 418, for example, based on a comparison between a priority of the particular data stream and a priority threshold, e.g., as described below.

In some demonstrative aspects, controller 410 may be configured to determine the identified data streams to be considered for setting the idle timeout period value 418 to include data streams having a priority, which is equal to or greater than the priority threshold, e.g., as described below.

In other aspects, controller 410 may be configured to determine the identified data streams to be considered for setting the idle timeout period value 418 based on any other additional or alternative criteria.

In some demonstrative aspects, controller 410 may be configured to determine the idle timeout period value 418, for example, based on end-to-end network latencies of the identified data streams, e.g., as described below.

In some demonstrative aspects, controller 410 may be configured to determine the idle timeout period value 418, for example, based on a highest, e.g., maximal, end-to-end network latency of the end-to-end network latencies of the identified data streams, e.g., as described below.

In other aspects, controller 410 may be configured to determine the idle timeout period value 418 based on any other criteria corresponding to the identified data streams.

In some demonstrative aspects, as shown in FIG. 4, the idle timeout period value 418 may be provided to a power manager 420, e.g., as described below.

In some demonstrative aspects, power manager 420 may be implemented and/or included as part of controller 124 (FIG. 1). For example, controller 124 (FIG. 1) may implement one or more elements of power management module 420, and/or may perform one or more operations and/or functionalities of power management module 420.

In some demonstrative aspects, power manager 420 may be implemented and/or included as part of a host processor of device 102 (FIG. 1).

In some demonstrative aspects, power manager 420 may be implemented and/or included as part of any other element and/or component of device 102 (FIG. 1).

In some demonstrative aspects, power manager 420 may be configured to set and/or adjust an idle timeout period of a wireless communication link, e.g., wireless communication link 113 (FIG. 1), for example, based on the idle timeout period value 418.

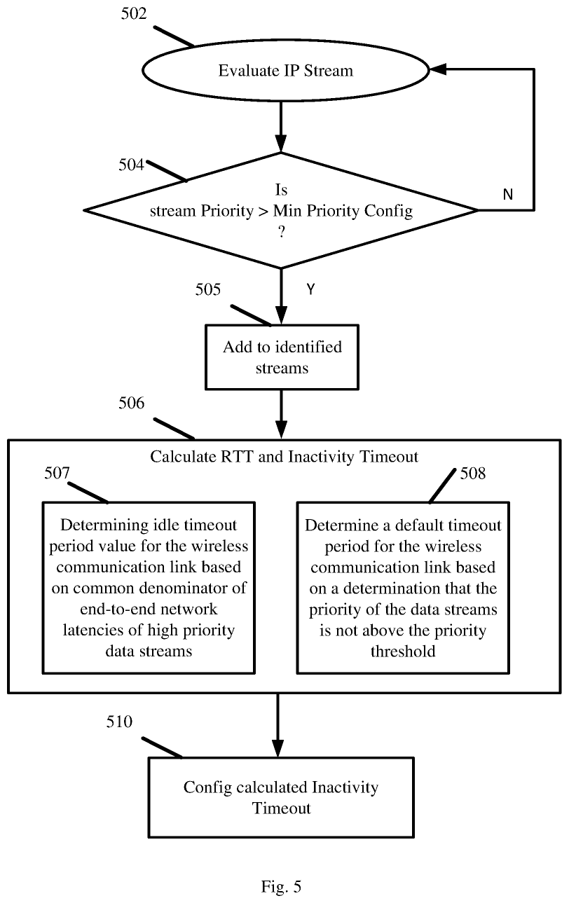

Reference is made to FIG. 5, which schematically illustrates a method of setting an idle timeout period for a wireless communication link, in accordance with some demonstrative aspects. For example, one or more operations of the method of FIG. 5, may be performed by one or more elements of a system, e.g., system 100 (FIG. 1), for example, a wireless communication device, e.g., device 102 (FIG. 1), and/or a controller, e.g., controller 124 (FIG. 1), and/or controller 410 (FIG. 4).

In some demonstrative aspects, as indicated at block 502, the method may include evaluating a priority of a data stream. For example, controller 124 (FIG. 1) may be configured to identify a priority of data stream 115 (FIG. 1), e.g., as described above.

In some demonstrative aspects, as indicated at block 504, the method may include determining whether the priority of the data stream is equal to or above a priority threshold. For example, controller 124 (FIG. 1) may be configured to determine whether the priority of data stream 115 (FIG. 1) is equal to or above the priority threshold, e.g., as described above.

In some demonstrative aspects, as indicated at block 505, the method may include determining that the data stream is identified to be considered for setting an idle timeout value, for example, based on a determination that the priority of the data stream is equal to or above the priority threshold. For example, controller 124 (FIG. 1) may be configured to identify that the data stream 115 (FIG. 1) is to be considered for setting an idle timeout value, for example, based on the determination that the priority of the data stream 115 (FIG. 1) is above or equal to the priority threshold, e.g., as described above.

In some demonstrative aspects, as indicated at block 506, the method may include determining an idle timeout period value for the wireless communication link, for example, based on end-to-end network latencies of the data streams included in the data streams identified based on the priority threshold. For example, controller 124 (FIG. 1) may be configured to determine the idle timeout period value for the wireless communication link 115 (FIG. 1), for example, based on end-to-end network latencies of the data streams included in the data streams identified based on the priority threshold, e.g., as described above.

In some demonstrative aspects, as indicated at block 507, the method may include determining an idle timeout period value for the wireless communication link, for example, based on a common denominator of end-to-end network latencies of high priority data streams, e.g., data streams identified as having the priority equal to or above the priority threshold. For example, controller 124 (FIG. 1) may be configured to determine the idle timeout period for the wireless communication link 113 (FIG. 1), for example, based on the maximal end-to-end network latency of the plurality of end-to-end network latencies for the plurality of data streams communicated via wireless communication link 113 (FIG. 1), e.g., as described above.

In some demonstrative aspects, as indicated at block 508, the method may include determining a default timeout period for the wireless communication link, for example, based on a determination that the priority of the data streams, e.g., any data stream, communicated via the wireless communication link, is not above the priority threshold. For example, controller 124 (FIG. 1) may be configured to set the default time out period for the wireless communication link 113 (FIG. 1), for example, based on the determination that the priority of any data stream 115 communicated via the link 113 (FIG. 1) is not above the priority threshold, e.g., as described above.

In some demonstrative aspects, as indicated at block 510, the method may include setting the idle timeout period for the wireless communication link, for example, according to the idle timeout period determined at block 506. For example, controller 124 (FIG. 1) may be configured to cause, trigger, instruct and/or control the wireless communication device 102 (FIG. 1) to set the idle time out period for the wireless communication link 113 (FIG. 1), e.g., as described above.

In one example, a wireless communication device, e.g., wireless communication device 102 (FIG. 1), may communicate a plurality of data streams, denoted S1-S4, with a plurality of endpoints (Peers), denoted 1-3, via a wireless communication link, for example, wireless communication link 113 (FIG. 1), e.g., as follows:

TABLE 1

| Stream | Peer | Priority |
|---|---|---|
| S1 | 1 | 5 |
| S2 | 1 | 0 |
| S3 | 2 | 7 |
| S4 | 3 | 3 |

For example, the plurality of peers may have different RTTs, e.g., as follows:
Peer1 RTT is 110 ms;
Peer2 RTT is 150 ms;
Peer3 RTT is 80 ms.

According to this example, the stream S1 with Peer 1, the stream S2 with Peer 1, and the stream S3 with Peer 2 may experience additional latency, for example, when a default idle timeout of 100 ms is used. For example, this additional latency may be caused since the network latencies of these streams being greater than 100 ms.

According to this example, controller 124 (FIG. 1) may be configured to set the idle timeout period for the wireless communication link, for example, based on a maximal end-to-end network latency of the plurality of end-to-end network latencies of streams having priority above a priority threshold. For example, the priority threshold may be set to three, e.g., as described below.

For example, controller 124 (FIG. 1) may be configured to identify the RTT of streams S1 and S3, for example, based on the determination that the priority of the stream S1, e.g., the priority 5, and a priority of the stream S3, the priority 7, are above the priority threshold of three, e.g., as follows:
S1 RTT is 110 ms (Peer1);
S3 RTT is 150 ms (Peer2).

For example, controller 124 (Gig. 1) may be configured to set the idle timeout period for the wireless communication link to 150 ms, for example, based on the maximal end-to-end network latency, which corresponds to the stream S3, e.g., MAX(Peer1 RTT, Peer2 RTT)=150 ms.

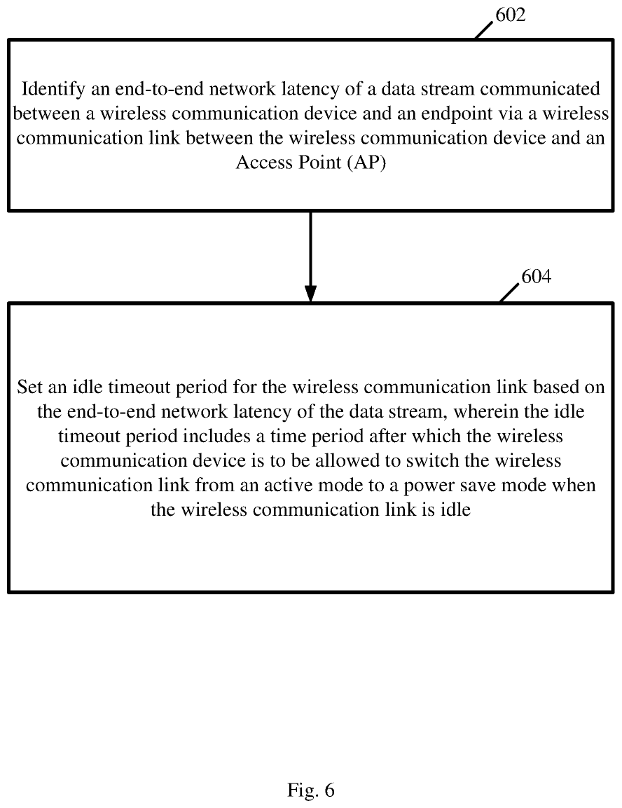

Reference is made to FIG. 6, which schematically illustrates a method of setting an idle timeout period for a wireless communication link, in accordance with some demonstrative aspects. For example, one or more operations of the method of FIG. 6, may be performed by one or more elements of a system, e.g., system 100 (FIG. 1), for example, a wireless communication device, e.g., device 102 (FIG. 1), and/or a controller, e.g., controller 124 (FIG. 1), and/or controller 410 (FIG. 4).

In some demonstrative aspects, as indicated at block 602, the method may include identifying at a wireless communication device an end-to-end network latency of a data stream communicated between the wireless communication device and an endpoint via a wireless communication link between the wireless communication device and an AP. For example, controller 124 (FIG. 1) may be configured to identify the end-to-end network latency of the data stream 115 (FIG. 1) communicated between the wireless communication device 102 (FIG. 1) and the endpoint 142 (FIG. 1) via the wireless communication link 113 (FIG. 1) between the wireless communication device 102 (FIG. 1) and the AP 104 (FIG. 1), e.g., as described above.

In some demonstrative aspects, as indicated at block 604, the method may include setting an idle timeout period for the wireless communication link based on the end-to-end network latency of the data stream. For example, the idle timeout period may include a time period after which the wireless communication device may be allowed to switch the wireless communication link from an active mode to a power save mode when the wireless communication link is idle. For example, controller 124 (FIG. 1) may be configured to cause, trigger, instruct and/or control the wireless communication device 102 (FIG. 1) to set the idle timeout period for the wireless communication link 113 (FIG. 1) based on the end-to-end network latency of the data stream 115 (FIG. 1), e.g., as described above.

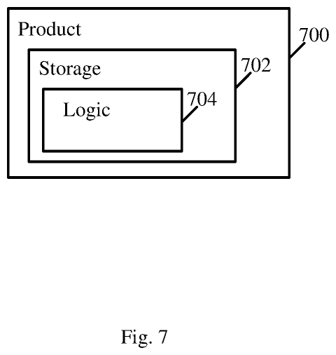

Reference is made to FIG. 7, which schematically illustrates a product of manufacture 700, in accordance with some demonstrative aspects. Product 700 may include one or more tangible computer-readable (“machine-readable”) non-transitory storage media 702, which may include computer-executable instructions, e.g., implemented by logic 704, operable to, when executed by at least one computer processor, enable the at least one computer processor to implement one or more operations at device 102 (FIG. 1), controller 124 (FIG. 1), controller 410 (FIG. 4), radio 114 (FIG. 1), receiver 116 (FIG. 1), transmitter 118 (FIG. 1), and/or message processor 128 (FIG. 1), to cause device 102 (FIG. 1), controller 124 (FIG. 1), controller 410 (FIG. 4), radio 114 (FIG. 1), receiver 116 (FIG. 1), transmitter 118 (FIG. 1), and/or message processor 128 (FIG. 1) to perform, trigger and/or implement one or more operations and/or functionalities, and/or to perform, trigger and/or implement one or more operations and/or functionalities described with reference to the FIGS. 1-6, and/or one or more operations described herein. The phrases “non-transitory machine-readable medium” and “computer-readable non-transitory storage media” may be directed to include all computer-readable media, with the sole exception being a transitory propagating signal.

In some demonstrative aspects, product 700 and/or machine-readable storage media 702 may include one or more types of computer-readable storage media capable of storing data, including volatile memory, non-volatile memory, removable or non-removable memory, erasable or non-erasable memory, writeable or re-writeable memory, and the like. For example, machine-readable storage media 702 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a Solid State Drive (SSD), and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 704 may include instructions, data, and/or code, which, if executed by a machine, may cause the machine to perform a method, process, and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 704 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner, or syntax, for instructing a processor to perform a certain function. The instructions may be implemented using any suitable high-level, low-level, object-oriented, visual, compiled and/or interpreted programming language.

### EXAMPLES

The following examples pertain to further aspects.

Example 1 includes an apparatus comprising circuitry and logic configured to cause a wireless communication device to identify an end-to-end network latency of a data stream communicated between the wireless communication device and an endpoint via a wireless communication link between the wireless communication device and an Access Point (AP); and set an idle timeout period for the wireless communication link based on the end-to-end network latency of the data stream, wherein the idle timeout period comprises a time period after which the wireless communication device is to be allowed to switch the wireless communication link from an active mode to a power save mode when the wireless communication link is idle.

Example 2 includes the subject matter of Example 1, and optionally, wherein the apparatus is configured to cause the wireless communication device to set a first idle timeout period for the wireless communication link based on a determination that the end-to-end network latency of the data stream is a first end-to-end network latency, and to set a second idle timeout period for the wireless communication link based on a determination that the end-to-end network latency of the data stream is a second end-to-end network latency, wherein the second idle timeout period is different from the first idle timeout period, and the second end-to-end network latency is different from the first end-to-end network latency.

Example 3 includes the subject matter of Example 2, and optionally, wherein the second idle timeout period is longer than the first idle timeout period, and the second end-to-end network latency is greater than the first end-to-end network latency.

Example 4 includes the subject matter of any one of Examples 1-3, and optionally, wherein the apparatus is configured to cause the wireless communication device to adjust the idle timeout period for the wireless communication link based on a change in the end-to-end network latency.

Example 5 includes the subject matter of Example 4, and optionally, wherein the apparatus is configured to cause the wireless communication device to increase the idle timeout period for the wireless communication link based on an increase in the end-to-end network latency.

Example 6 includes the subject matter of any one of Examples 1-5, and optionally, wherein the apparatus is configured to cause the wireless communication device to determine, based on a priority of the data stream, whether the idle timeout period is to be set based on the end-to-end network latency of the data stream.

Example 7 includes the subject matter of any one of Examples 1-6, and optionally, wherein the apparatus is configured to cause the wireless communication device to determine, based on a comparison between a priority of the data stream and a priority threshold, whether the idle timeout period is to be set based on the end-to-end network latency of the data stream.

Example 8 includes the subject matter of Example 7, and optionally, wherein the apparatus is configured to cause the wireless communication device to set a first idle timeout period based on the end-to-end network latency of the data stream, based on a determination that the priority of the data stream is above the priority threshold; and to set a second idle timeout period, based on a determination that the priority of the data stream is not above the priority threshold, wherein the first idle timeout period is longer than the second idle timeout period.

Example 9 includes the subject matter of Example 8, and optionally, wherein the second idle timeout period comprises a default timeout period.

Example 10 includes the subject matter of any one of Examples 1-9, and optionally, wherein the apparatus is configured to cause the wireless communication device to set the idle timeout period for the wireless communication link based on an other end-to-end network latency of an other data stream communicated between the wireless communication device and an other endpoint via the wireless communication link.

Example 11 includes the subject matter of any one of Examples 1-10, and optionally, wherein the apparatus is configured to cause the wireless communication device to set the idle timeout period for the wireless communication link based on a criterion corresponding to a plurality of end-to-end latencies corresponding to a plurality of data streams communicated via the wireless communication link.

Example 12 includes the subject matter of Example 11, and optionally, wherein the apparatus is configured to cause the wireless communication device to set the idle timeout period for the wireless communication link based on a maximal end-to-end network latency of the plurality of end-to-end network latencies.

Example 13 includes the subject matter of Example 11 or 12, and optionally, wherein the apparatus is configured to cause the wireless communication device to determine whether to include a particular data stream in the plurality of data streams based on a priority of the particular data stream.

Example 14 includes the subject matter of Example 13, and optionally, wherein the apparatus is configured to cause the wireless communication device to determine whether to include the particular data stream in the plurality of data streams based on a comparison between the priority of the particular data stream and a priority threshold.

Example 15 includes the subject matter of any one of Examples 1-14, and optionally, wherein the apparatus is configured to prohibit the wireless communication device from switching the wireless communication link to the power save mode when the link is idle for a time period shorter than the idle timeout period.

Example 16 includes the subject matter of any one of Examples 1-15, and optionally, wherein the apparatus is configured to set the idle timeout period to be equal to or greater than the end-to-end network latency of the data stream.

Example 17 includes the subject matter of any one of Examples 1-16, and optionally, wherein the apparatus is configured to cause the wireless communication device to identify the end-to-end network latency of the data stream based on a Round Trip Time (RTT) between the wireless communication device and the endpoint.

Example 18 includes the subject matter of any one of Examples 1-17, and optionally, comprising a radio to communicate the data stream.

Example 19 includes the subject matter of Example 18, and optionally, comprising one or more antennas connected to the radio, a memory, and a processor to execute instructions of an operating system of the wireless communication device.

Example 20 comprises a wireless communication device comprising the apparatus of any of Examples 1-19.

Example 21 comprises an apparatus comprising means for executing any of the described operations of any of Examples 1-19.

Example 22 comprises a product comprising one or more tangible computer-readable non-transitory storage media comprising computer-executable instructions operable to, when executed by at least one processor, enable the at least one processor to cause a wireless communication device to perform any of the described operations of any of Examples 1-19.

Example 23 comprises an apparatus comprising: a memory interface; and processing circuitry configured to: perform any of the described operations of any of Examples 1-19.

Example 24 comprises a method comprising any of the described operations of any of Examples 1-19.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising circuitry and logic configured to cause a wireless communication device to:
identify an end-to-end network latency of a data stream communicated between the wireless communication device and an endpoint via a wireless communication link between the wireless communication device and an Access Point (AP); and
set an idle timeout period for the wireless communication link based on the end-to-end network latency of the data stream, wherein the idle timeout period comprises a time period after which the wireless communication device is to be allowed to switch the wireless communication link from an active mode to a power save mode when the wireless communication link is idle.

2. The apparatus of claim 1 configured to cause the wireless communication device to set a first idle timeout period for the wireless communication link based on a determination that the end-to-end network latency of the data stream is a first end-to-end network latency, and to set a second idle timeout period for the wireless communication link based on a determination that the end-to-end network latency of the data stream is a second end-to-end network latency, wherein the second idle timeout period is different from the first idle timeout period, and the second end-to-end network latency is different from the first end-to-end network latency.

3. The apparatus of claim 2, wherein the second idle timeout period is longer than the first idle timeout period, and the second end-to-end network latency is greater than the first end-to-end network latency.

4. The apparatus of claim 1 configured to cause the wireless communication device to adjust the idle timeout period for the wireless communication link based on a change in the end-to-end network latency.

5. The apparatus of claim 4 configured to cause the wireless communication device to increase the idle timeout period for the wireless communication link based on an increase in the end-to-end network latency.

6. The apparatus of claim 1 configured to cause the wireless communication device to determine, based on a priority of the data stream, whether the idle timeout period is to be set based on the end-to-end network latency of the data stream.

7. The apparatus of claim 1 configured to cause the wireless communication device to determine, based on a comparison between a priority of the data stream and a priority threshold, whether the idle timeout period is to be set based on the end-to-end network latency of the data stream.

8. The apparatus of claim 7 configured to cause the wireless communication device to set a first idle timeout period based on the end-to-end network latency of the data stream, based on a determination that the priority of the data stream is above the priority threshold; and to set a second idle timeout period, based on a determination that the priority of the data stream is not above the priority threshold, wherein the first idle timeout period is longer than the second idle timeout period.

9. The apparatus of claim 8, wherein the second idle timeout period comprises a default timeout period.

10. The apparatus of claim 1 configured to cause the wireless communication device to set the idle timeout period for the wireless communication link based on an other end-to-end network latency of an other data stream communicated between the wireless communication device and an other endpoint via the wireless communication link.

11. The apparatus of claim 1 configured to cause the wireless communication device to set the idle timeout period for the wireless communication link based on a criterion corresponding to a plurality of end-to-end latencies corresponding to a plurality of data streams communicated via the wireless communication link.

12. The apparatus of claim 11 configured to cause the wireless communication device to set the idle timeout period for the wireless communication link based on a maximal end-to-end network latency of the plurality of end-to-end network latencies.

13. The apparatus of claim 11 configured to cause the wireless communication device to determine whether to include a particular data stream in the plurality of data streams based on a priority of the particular data stream.

14. The apparatus of claim 13 configured to cause the wireless communication device to determine whether to include the particular data stream in the plurality of data streams based on a comparison between the priority of the particular data stream and a priority threshold.

15. The apparatus of claim 1 configured to prohibit the wireless communication device from switching the wireless communication link to the power save mode when the link is idle for a time period shorter than the idle timeout period.

16. The apparatus of claim 1 configured to set the idle timeout period to be equal to or greater than the end-to-end network latency of the data stream.

17. The apparatus of claim 1 configured to cause the wireless communication device to identify the end-to-end network latency of the data stream based on a Round Trip Time (RTT) between the wireless communication device and the endpoint.

18. The apparatus of claim 1 comprising a radio to communicate the data stream.

19. The apparatus of claim 18 comprising one or more antennas connected to the radio, a memory, and a processor to execute instructions of an operating system of the wireless communication device.

20. A product comprising one or more tangible computer-readable non-transitory storage media comprising instructions operable to, when executed by at least one processor, enable the at least one processor to cause a wireless communication device to:
identify an end-to-end network latency of a data stream communicated between the wireless communication device and an endpoint via a wireless communication link between the wireless communication device and an Access Point (AP); and
set an idle timeout period for the wireless communication link based on the end-to-end network latency of the data stream, wherein the idle timeout period comprises a time period after which the wireless communication device is to be allowed to switch the wireless communication link from an active mode to a power save mode when the wireless communication link is idle.

21. The product of claim 20, wherein the instructions, when executed, cause the wireless communication device to set a first idle timeout period for the wireless communication link based on a determination that the end-to-end network latency of the data stream is a first end-to-end network latency, and to set a second idle timeout period for the wireless communication link based on a determination that the end-to-end network latency of the data stream is a second end-to-end network latency, wherein the second idle timeout period is different from the first idle timeout period, and the second end-to-end network latency is different from the first end-to-end network latency.

22. The product of claim 20, wherein the instructions, when executed, cause the wireless communication device to adjust the idle timeout period for the wireless communication link based on a change in the end-to-end network latency.

23. The product of claim 20, wherein the instructions, when executed, cause the wireless communication device to set the idle timeout period for the wireless communication link based on an other end-to-end network latency of an other data stream communicated between the wireless communication device and an other endpoint via the wireless communication link.

24. An apparatus for a wireless communication device, the apparatus comprising:
means for identifying an end-to-end network latency of a data stream communicated between the wireless communication device and an endpoint via a wireless communication link between the wireless communication device and an Access Point (AP); and
means for causing the wireless communication device to set an idle timeout period for the wireless communication link based on the end-to-end network latency of the data stream, wherein the idle timeout period comprises a time period after which the wireless communication device is to be allowed to switch the wireless communication link from an active mode to a power save mode when the wireless communication link is idle.

25. The apparatus of claim 24 comprising means for causing the wireless communication device to set a first idle timeout period for the wireless communication link based on a determination that the end-to-end network latency of the data stream is a first end-to-end network latency, and to set a second idle timeout period for the wireless communication link based on a determination that the end-to-end network latency of the data stream is a second end-to-end network latency, wherein the second idle timeout period is different from the first idle timeout period, and the second end-to-end network latency is different from the first end-to-end network latency.
